(19) United States
(12) Patent Application Publication
(10) Pub. No.: US 2005/0094617 A1
(43) Pub. Date: May 5, 2005

(54) Wireless network synchronization system and method

(75) Inventor: Chang-Hung Lee, Yuan Lin Hsien (TW)

Correspondence Address: Ladas & Parry, 26 West 61st Street, New York, NY, 10023, US

(73) Assignee: BENQ CORPORATION

(21) Appl. No.: 10/973,867

(22) Filed: Oct. 26, 2004

(30) Foreign Application Priority Data
Oct. 31, 2003 (TW) 92130429

(51) Int. Cl. H04J 3/06; H04M 3/00

(52) U.S. Cl. 370/350; 455/419; 717/168

(57) ABSTRACT

A wireless network synchronization system for updating data in a memory within a mobile unit on the Internet includes a data server and an access point (AP). The data server is located on the Internet to provide an update data. The AP is linked to the Internet to access the data in the data server and transmit the update data in a packet format to the mobile unit. When the mobile unit is linked to the AP, the AP transmits the packet containing the update data in a broadcast mode to the mobile unit to update the data in the memory thereof.

### BACKGROUND OF THE INVENTION

(1) Field of the Invention

The invention relates to a wireless network synchronization system and method, and more particularly to a wireless network synchronization system and method that has access points to update selected data of mobile units.

(2) Description of the Prior Art

Since the Internet has been invented, it was rapidly woven into people's life. The early Internet communicates any two network devices through a wired transmission. To meet people's requirements of wireless data transmission, many network devices equipped with wireless data transmission function have been developed and introduced in recent years. These days, it is possible to communicate any two network equipment through wireless transmission on the Internet.

In a Wireless Local Area Network (WLAN), there are two main equipment, namely the WLAN card and Access Point (AP). The basic structure of the WLAN card is similar to the wired network card. The main difference is that on the WLAN card data information transmission and receiving are performed in a wireless transmission mode. A conventional wired network card can become a WLAN card by adding a wireless transceiver/receiver module. The AP mainly is established on a distal end of the wired network to transmit data from the wired network to the WLAN card of a user end through a wireless transceiver/receiver module.

Refer to FIG. 1 for the basic architecture of a WLAN. There is a WLAN card (not shown in the drawing) in each of mobile units 10. An AP 12 can access the Internet 16 through a wired network 14 (such as Ethernet, cable TV line, etc.). Through the interaction of the WLAN card and the AP 12, the mobile units 10 can transmit data and messages with the servers or other mobile units on the Internet 16.

As the WLAN environment is easy to set up, maintain and highly mobile, the conventional wired network in the houses, offices and schools has gradually been replaced by WLAN. Recently, even some cafes, restaurants, waiting lounges of airports, VIP rooms, shops in the department stores, hotels, railway and bus stations have set up the WLAN structure to provide a networking environment for people and business persons to use.

The WLAN structure in the public places is especially popular. It also is called a hot spot. In such an environment covered by an AP 12, a mobile unit 10 (such as a notebook computer, PDA, or the like) equipped with a WLAN card can be linked to the Internet and receive and send e-mail. And business persons on the move can exchange information and messages with the company and customers anytime desired.

However, in the architecture set forth above, AP 12 functions only as a bridge. Its main function is to receive and transmit data between the mobile unit 10 and the Internet 16, and communicate among a plurality of mobile units 10. It does not provide other function. Hence when a user travels outside a time zone, he/she has to manually set time on the mobile unit 10. If he/she forget making the setting, the message sent by the mobile unit 10 (such as e-mail) will have a wrong time data on the receiving end. It is a serious fault for time-conscious business persons. Therefore the present invention aims to provide a wireless network synchronization system and method that has access points to update selected data of the mobile units.

### SUMMARY OF THE INVENTION

Accordingly, it is an object of the invention is to provide a wireless network synchronization system.

Another object of the invention is to provide a wireless network synchronization method.

Yet another object of the invention is to provide a wireless network synchronization system and method that has access points to update selected data of mobile units.

In one embodiment, the wireless network synchronization system of the invention is adopted for use on a network, for example the Internet, to update data in the memory of mobile units through an AP. The wireless network synchronization system includes a data server and an AP. The data server is any data server on the Internet to provide an update data (including instant time, instant news messages, commercial messages, etc.). The AP is connected to the Internet to access the data server and transmit the update data in a packet format to the connecting mobile unit.

When the mobile unit is connected to the AP, the AP transmits the packet containing the update data in a broadcast mode to the mobile unit for updating the data in the memory thereof. The updating process may be performed automatically or manually selected by users.

According to one embodiment of the wireless network synchronization system of the invention, the AP includes at least a data access module, a table, a data distribution module and a wireless transceiver/receiver module. The data access module aims to access data of a data server on the Internet. The table is to store the data accessed by the data access module. The data distribution module transmits the data stored in the table through the wireless transceiver/receiver module to the mobile unit linked to the AP. In addition, the table also stores update records of the mobile unit. Hence when the table has the records of the mobile unit, the AP skips transmitting the update data to the mobile unit. If the table does not have the records of the mobile unit, the AP transmits the update data to the mobile unit.

According an embodiment of the wireless network synchronization method of the invention, the following steps are included: first, access an update data in any data server on the Internet, the address of the data server (may be an IP address or a domain name) may be preset or set by users; next, store the update data in a table of an AP; then transmit the update data in a packet format and a broadcast mode to a mobile unit; finally, update the data in the memory of the mobile unit. The mobile unit may be a notebook, PDA, pocket PC, or even a desktop computer.

### BRIEF DESCRIPTION OF THE DRAWINGS

The present invention will now be specified with reference to its preferred embodiment illustrated in the drawings, in which:

FIG. 1 is a schematic view of the basic architecture of a WLAN;

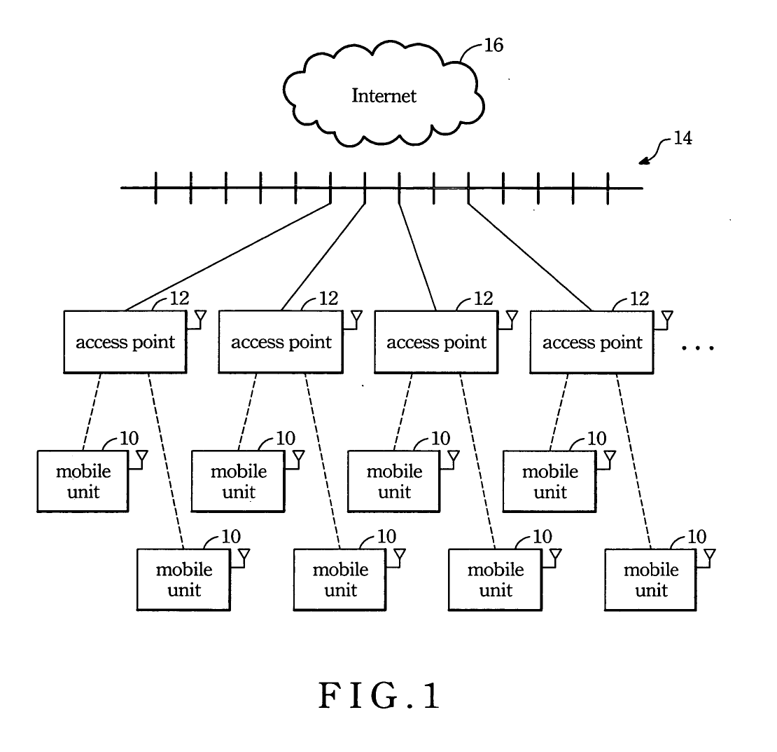

FIG. 2 is a schematic view of the architecture of an embodiment the wireless network synchronization system of the present invention; and

FIG. 3 is the process flow chart of an embodiment the wireless network synchronization method of the present invention.

### DESCRIPTION OF THE PREFERRED EMBODIMENTS

The wireless network synchronization system according to the present invention aims to update selected data in a mobile unit through an AP to achieve data synchronization purpose. Details of the invention are elaborated below by referring to an embodiment. The embodiment is for illustrative purpose only and is not the limitation of the invention.

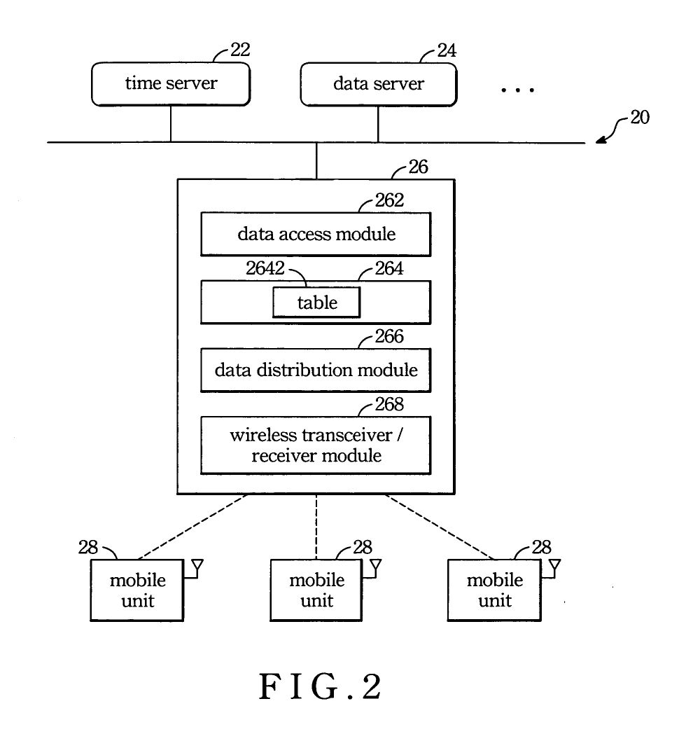

Refer to FIG. 2 for the architecture of an embodiment the wireless network synchronization system of the present invention. The wireless network synchronization system is for use on the Internet to update selected data in the memory (not shown in the drawing) within a mobile unit 28 through an AP 26. The wireless network synchronization system includes a data server 24 and the AP 26. The data server 24 is any data server on the Internet to provide an update data (including instant time, instant news, commercial messages, etc.). The AP 26 accesses the Internet through a wired network 20 (such as Ethernet, cable TV lines, etc.) to access the update data in the data server 24, and transmits the update data in a packet format to the linking mobile unit 28. The address of the data server 24 (may be an IP address or a domain name) may be preset in the AP 26 or set by users. The timing of the AP 26 to access data in the data server 24 may be set periodically with a predetermined time interval, or access the update data in the data server 24 when the mobile unit 28 is linked to the AP 26.

When any mobile unit 28 is linked to the AP 26, the AP sets the packet containing the update data in a broadcast mode to transmit the packet to the mobile unit 28 to update the data in the memory (not shown in the drawings) of the mobile unit 28. Users can select automatic or manual update. The mobile unit 28 may be a notebook, PDA, pocket PC, or even a desktop computer.

According one embodiment of the wireless network synchronization system of the present invention, the AP 26 includes at least a data access module 262, a memory 264, a data distribution module 266 and a wireless transceiver/receiver module 268. The data access module 262 aims to access update data in a data server 24 on the Internet, and store the update data in the memory 264 of the AP 26. The memory 264 has a table 2642 to store the update data retrieved from the data server 24. The data distribution module 266 transmits the data stored in the table 2642 through the wireless transceiver/receiver module 268 to the mobile unit 28 linking to the AP 26.

It is to be noted that the table 2642 also stores update records of the mobile unit 28. Hence when the table 2642 has the records of the mobile unit 28, the AP 26 skips transmitting the update data to the mobile unit 28. On the contrary, if the table 2642 does not have any record of the mobile unit 28, the AP 26 transmits the update data to the mobile unit 28. In addition, the programs required for data access and distribution may be stored respectively inside or outside the data access module 262 and data distribution module 266 as long as the data access and distribution functions can be accomplished.

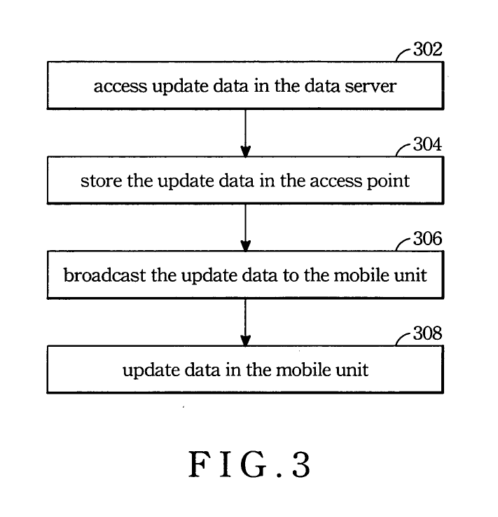

Refer to FIG. 3 for the process flow chart of an embodiment the wireless network synchronization method of the present invention. The method includes the following procedures. Firstly is to access an update data in any data server on the Internet (302), the address of the data server (may be an IP address or a domain name) can be preset in an AP or set by users. Next is to store the update data in a table of the AP (304). Subsequent is to transmit the update data in a packet format and a broadcast mode to the mobile unit (306). Finally is to update the data in the memory of the mobile unit (308) to synchronize the data.

Take update of instant time as an example. According to a data server address stored in the AP 26 (namely a time server 22), such as clepsydra.dec.com, ben.cs.wisc.edu, truechimer.waikato.ac.nz, etc., the AP 26 can access the address to retrieve instant time data. In addition, to maintain the accuracy of time, an automatic time synchronization is performed periodically. It is to be noted that selection of the desired time server address is based on the location. To take into account of network delay, the time server 22 most close to the AP 26 should be selected. Moreover, the AP 26 and the time server 22 must be located on the same time zone.

When a mobile unit 28 is linked to the AP 26, the AP 26 first checks the table 2642 for linking records with the mobile unit 28 in a selected time period. If no linking record is found, a packet containing the instant time is sent in a broadcast mode to the mobile unit 28 linking to the AP 26 in the same domain to update the time data stored in the memory of the mobile unit 28. For setting the broadcast packet, in TCP/IP, Network Time Protocol (NTP) is adopted. In addition, the domain address (IP address) data is set (such as 192.168.xxxx). Then the instant time can be broadcast to the mobile units in the same domain. If the update data is instant news or commercial message, it is sent in an object format to the mobile unit 28, and the screen of the mobile unit 28 displays a message frame to transmit the instant message.

The wireless network synchronization system of the invention has the following advantages:

(1) By means of the design of AP in the invention, time data of the mobile units can be updated synchronously. Therefore when a user travels and crosses a time zone, he/she does not have to change time setting procedures. The error resulting from forgetting altering time setting may be avoided.

(2) By means of the design of the present invention, instant news and commercial messages may be broadcast through the AP so that the mobile units within the domain can receive instant information and the AP is not limited to providing the bridge function, but also can function as a relay station for message broadcasting.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A wireless network synchronization system for using in a network to update data in a memory of a mobile unit, comprising:
a data server connecting the network for providing an update data; and
an access point (AP) connecting the network to access the data server and transmit the update data in a packet format to the mobile unit;
wherein said AP transmits the update data to the mobile unit in a broadcast mode when the mobile unit is linked to said AP to update data in the memory.

2. The wireless network synchronization system of claim 1, wherein the AP further includes:
a data access module for accessing said data server and getting the update data;
a table for storing the update data;
a wireless transceiver/receiver module; and
a data distribution module for transmitting the update data stored in said table through the wireless transceiver/receiver module to the mobile unit.

3. The wireless network synchronization system of claim 2, wherein said table further comprises at least one update record of the mobile unit.

4. The wireless network synchronization system of claim 3, wherein said AP skips transmit the update data to the mobile unit when said table contains the at least one record of the mobile unit.

5. The wireless network synchronization system of claim 3, wherein said AP transmits the update data to the mobile unit when said table does not contain any update record of the mobile unit.

6. The wireless network synchronization system of claim 1, wherein an address of said data server is preset or set by users.

7. The wireless network synchronization system of claim 1, wherein the mobile unit updates the data in the memory of the mobile unit is selectively performed automatically and manually.

8. The wireless network synchronization system of claim 1, wherein the update data is instant time.

9. The wireless network synchronization system of claim 1, wherein the update data is instant news.

10. The wireless network synchronization system of claim 1, wherein the update data is retrieved by said AP from said data server periodically with a predetermined time interval.

11. The wireless network synchronization system of claim 1, wherein the update data is retrieved by said AP from said data server while the mobile unit is connecting to said AP.

12. A wireless network synchronization method for a access point (AP) updating data in a memory of a mobile unit, the AP connecting a network, the network connecting a plurality of data servers, the method comprising the steps of:
accessing an update data in one of said data servers;
storing the update data in said AP;
transmitting the update data to the mobile unit in a packet format and a broadcast mode when the mobile unit connecting the AP.

13. The wireless network synchronization method of claim 12, wherein said AP includes:
a data access module for accessing the update data in said data server;
a table for storing the update data;
a wireless transceiver/receiver module; and
a data distribution module for transmitting the update data stored in said table through the wireless transceiver/receiver module to the mobile unit.

14. The wireless network synchronization method of claim 12, wherein an address of said data server is preset or set by users.

15. The wireless network synchronization method of claim 12, wherein the mobile unit updates the data in the memory of the mobile unit is selectively performed automatically and manually.

16. The wireless network synchronization method of claim 12, wherein the data is instant time.

17. The wireless network synchronization method of claim 12, wherein the data is instant news.

18. The wireless network synchronization method of claim 12, wherein the update data is retrieved from one of said data servers periodically with a predetermined time interval.

19. The wireless network synchronization method of claim 12, wherein the update data is retrieved from one of said data servers while the mobile unit is connecting to said AP.

20. An access point (AP) for connecting a network and a mobile unit, the network connecting a plurality of data servers located thereon, the AP comprising:
a data access module for accessing an update data in one of said data servers;
a table for storing the update data;
a wireless transceiver/receiver module; and
a data distribution module for transmitting the update data in said table in a packet format and a broadcast mode through the wireless transceiver/receiver module while the mobile connecting to said AP.

21. The AP of claim 20, wherein said data access module accesses the update data in one of said data servers having an address for said data server setting by users.

22. The AP of claim 20, wherein the mobile unit is selected from the group consisting of a notebook, a PDA, a pocket PC and a desktop computer.

23. A wireless network synchronization method for a mobile unit to update data in a memory of a mobile unit according an access point (AP), the AP connecting a network, the network connecting a plurality of data servers, the method comprising the steps of:
connecting the AP;
receiving an updated data from the AP, the updated data broadcasted by the AP, the AP accessing in one of said data servers for getting the updated data; and
updating the data in the memory.
